(19) United States
(12) Patent Application Publication
(10) Pub. No.: US 2026/0311696 A1
(43) Pub. Date: Oct. 8, 2026

(54) METHOD AND APPARATUS FOR PROVIDING SERVICE FOR VOICE INTERACTION IN VEHICLE

(71) Applicants: Hyundai Motor Company, Seoul (KR); Kia Corporation, Seoul (KR)

(72) Inventor: Sung Soo PARK, Hwaseong-si (KR)

(73) Assignees: Hyundai Motor Company, Seoul (KR); Kia Corporation, Seoul (KR)

(21) Appl. No.: 19/322,377

(22) Filed: Sep. 8, 2025

(30) Foreign Application Priority Data
Apr. 2, 2025 (KR) 10-2025-0042981

(51) Int. Cl. G10L 15/22

(52) U.S. Cl. CPC G10L 15/22; G10L 2015/223

(57) ABSTRACT

A method and an apparatus are for providing a voice interaction service. A method for providing a voice interaction service includes: determining a confidence value using a first spoken voice of a user, comparing the confidence value with a predefined value to determine a voice interaction mode, the voice interaction mode including a first mode and a second mode, determining a response intent using the first spoken voice based on determining the voice interaction mode as the first mode, the response intent being an intent to be conveyed to the user, providing a feedback to the user using the response intent and maintaining or changing the voice interaction mode based on whether a second spoken voice of the user includes an intent slot, and the feedback.

### CROSS-REFERENCE TO RELATED APPLICATION

The present application claims the benefit of and priority to Korean Patent Application No. 10-2025-0042981, filed on Apr. 2, 2025, the entire disclosure(s) of which is incorporated herein by reference in its entirety.

### TECHNICAL FIELD

The present disclosure relates to a method and apparatus for providing a service for voice interaction in a vehicle. More specifically, the present disclosure relates to a method and apparatus for changing or maintaining a voice interaction mode based on whether an intent slot is included in a spoken voice of a user and whether a provided feedback is a feedback for requesting additional information.

### BACKGROUND

The content described below merely provides background information related to the present embodiment and does not form related art.

An in-vehicle assistant system (IVAS) is an artificial intelligence-based voice assistant system that supports a user and a vehicle to interact through voice. When a user speaks, IVAS of a vehicle recognizes the user's spoken voice and performs an appropriate function or provides a response voice to the user. IVAS automatically recognizes a user's voice, converts the same into text, and maintains a conversation context with the user using dialogue management (DM). Furthermore, IVAS performs natural language processing (NLP) to understand and interpret a spoken voice of a user and provides a response voice that matches the intent of the user.

When a user utilizes IVAS in a vehicle, IVAS may provide a response voice that does not match a user's intent during the process of performing natural language processing. For example, if a user's spoken voice includes a point-of-interest (POI) word and the POI word is the same as a word requiring additional information, IVAS may provide additional information that does not match the user's intent to the user as a response voice. Accordingly, research is required to prevent IVAS from providing a response voice that does not match a user's intent during the process of performing natural language processing.

### SUMMARY

The present disclosure determines whether a feedback for requesting additional information is provided to a user when a service for voice interaction is provided in a vehicle.

Furthermore, the present disclosure determines whether a user's spoken voice includes an intent slot when a service for voice interaction is provided in a vehicle.

Furthermore, the present disclosure changes or maintains a voice interaction mode.

The aspects of the present disclosure are not limited to the aspects mentioned above, and other aspects not mentioned will be clearly understood by those skilled in the art from the description below.

According to at least one embodiment, the present disclosure provides a voice interaction service. The apparatus for providing a voice interaction service, including: a mode determination unit configured to determine a confidence value using a first spoken voice of a user and compare the confidence value with a predefined value to determine a voice interaction mode, the voice interaction mode including a first mode and a second mode, the first mode being a mode for providing a response to the user, the second mode being a mode for performing a control operation, a feedback provision unit configured to determine a response intent using the first spoken voice based on determining the voice interaction mode as the first mode and provide a feedback to the user using the response intent, the response intent being an intent to be conveyed to the user, and a mode change unit configured to maintain or change the voice interaction mode based on whether a second spoken voice of the user includes an intent slot, and the feedback, wherein the first spoken voice is a voice spoken by the user before the feedback is provided, the second spoken voice is a voice spoken by the user after the feedback is provided, and the intent slot is a slot reflecting a user's intent.

According to another embodiment, the present disclosure provides a method for providing a voice interaction service. The method including: determining a confidence value using a first spoken voice of a user, comparing the confidence value with a predefined value to determine a voice interaction mode, the voice interaction mode including a first mode and a second mode, the first mode being a mode for providing a response to the user, the second mode being a mode for performing a control operation, determining a response intent using the first spoken voice based on determining the voice interaction mode as the first mode, the response intent being an intent to be conveyed to the user, providing a feedback to the user using the response intent and maintaining or changing the voice interaction mode based on whether a second spoken voice of the user includes an intent slot, and the feedback, wherein the first spoken voice is a voice spoken by the user before the feedback is provided, the second spoken voice is a voice spoken by the user after the feedback is provided, and the intent slot is a slot reflecting a user's intent.

According to yet another embodiment, the present disclosure provides a computer-readable medium storing a computer program including computer-executable instructions for causing, when executed by a computer, the computer to perform steps of determining a confidence value using a first spoken voice of a user, comparing the confidence value with a predefined value to determine a voice interaction mode, the voice interaction mode including a first mode and a second mode, the first mode being a mode for providing a response to the user, the second mode being a mode for performing a control operation, determining a response intent using the first spoken voice based on determining the voice interaction mode as the first mode, the response intent being an intent to be conveyed to the user, providing a feedback to the user using the response intent and maintaining or changing the voice interaction mode based on whether a second spoken voice of the user includes an intent slot, and the feedback, wherein the first spoken voice is a voice spoken by the user before the feedback is provided, the second spoken voice is a voice spoken by the user after the feedback is provided, and the intent slot is a slot reflecting a user's intent.

### ADVANTAGEOUS EFFECTS

According to an exemplary embodiment of the present disclosure, when a service for voice interaction is provided in a vehicle, it is possible to provide a response voice that matches a user's intent or perform a control operation.

The effects which may be obtained from the present disclosure are not limited to the effects mentioned above, and other effects that are not mentioned may be clearly understood by those with ordinary knowledge in the technical field to which the present disclosure belongs from the description below.

### BRIEF DESCRIPTION OF THE DRAWINGS

FIG. 1 is a block diagram illustrating an apparatus that provides a service for voice interaction in a vehicle according to an exemplary embodiment of the present disclosure.

FIG. 2 is a flowchart illustrating a process of determining a voice interaction mode according to an exemplary embodiment of the present disclosure.

FIG. 3 is a flowchart illustrating a process of changing or maintaining a voice interaction mode according to an exemplary embodiment of the present disclosure.

FIG. 4 is a flowchart illustrating a method of providing a service for voice interaction in a vehicle according to an exemplary embodiment of the present disclosure.

FIG. 5 is a block diagram schematically illustrating an exemplary computing device which may be used to implement the method according to an exemplary embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Furthermore, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout the present specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

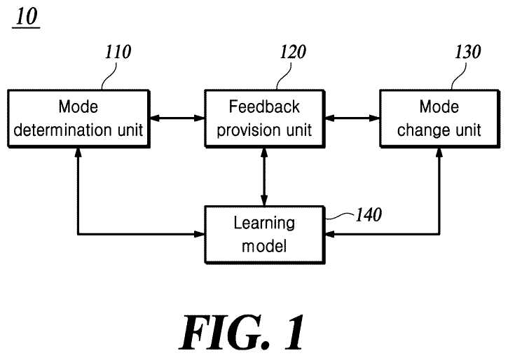

FIG. 1 is a block diagram illustrating an apparatus that provides a service for voice interaction in a vehicle according to an exemplary embodiment of the present disclosure.

Referring to FIG. 1, the apparatus that provides a service for voice interaction in a vehicle (hereinafter, “voice interaction service provision apparatus” 10) includes all or part of a mode determination unit 110, a feedback provision unit 120, a mode change unit 130, and a learning model 140. The voice interaction service provision apparatus 10 and each component thereof may be implemented as hardware or software, or may be implemented as a combination of hardware and software. Furthermore, the function of each component may be implemented as software, and one or more processors may be implemented to execute the function of the software corresponding to each component. Hereinafter, a user may be a driver driving a vehicle. The voice interaction service provision apparatus 10 may be disposed in a vehicle or may be disposed separately from a vehicle.

The mode determination unit 110 recognizes a spoken voice of a user and analyzes the intent of the user using the user's spoken voice to determine a voice interaction mode. The voice interaction mode may include a conversation mode and a control mode. The conversation mode may be a mode in which the voice interaction service provision apparatus 10 generates a response while maintaining a context with the user. The control mode may be a mode in which a user's spoken voice is understood and control is performed in accordance with a user's intent. The mode determination unit 110 may be configured to determine a confidence value using instructions, interrogatives, greetings, and words included in the user's spoken voice and compare the confidence value with a predefined value to determine a voice interaction mode.

The feedback provision unit 120 is configured to determine a response intent when the voice interaction mode is determined to be the conversation mode and provides a feedback to the user in a voice form. The response intent may be an intent that the voice interaction service provision apparatus 10 conveys to the user. The response intent may include an intent to request additional information, an intent to ask a question, an intent to convey that the spoken voice has not been understood, an intent to request a recommendation, an intent to provide information, an intent to chat, an intent to greet, and the like. Here, when the response intent is the intent to request additional information or the intent to ask a question, the feedback provided by the feedback provision unit 120 to the user may be a feedback with an intent to request additional information. When the response intent is the intent to convey that the spoken voice has not been understood, the intent to request a recommendation, the intent to provide information, the intent to chat, or the intent to greet, the feedback provided by the feedback provision unit 120 to the user may be feedback with an intent to provide information, an intent to chat, and an intent to end the conversation.

The mode change unit 130 changes or maintains the voice interaction mode based on whether the user's spoken voice includes an intent slot and whether a feedback provided before the user's spoken voice is recognized is a feedback for requesting additional information. The intent slot is a slot that clarifies or reflects the user's intent. For example, if the user's intent is to search for a point-of-interest (POI) location, the intent slot may be “close”, “around”, “nearby”, “on the way”, and “route”. If the user's intent is to search for music, the intent slot may be “popular”, “latest”, “recent”, “favorite”, and “recently”.

If the voice interaction mode is determined to be the control mode by the mode determination unit 110 and the user's spoken voice includes an intent slot, the mode change unit 130 may continuously maintain the voice interaction mode as the control mode. If the voice interaction mode is determined to be the control mode by the mode determination unit 110 and the user's spoken voice does not include an intent slot, the mode change unit 130 may be configured to determine whether the feedback provided before the user's spoken voice is recognized is a feedback for requesting additional information. If the feedback provided before the user's spoken voice is recognized is a feedback for requesting additional information, the mode change unit 130 may change the voice interaction mode from the control mode to the conversation mode.

The learning model 140 may be a trained learning model. The learning model 140 may be a model based on deep learning. The voice interaction service provision apparatus 10 may additionally include a learning unit for training the learning model 140 in advance. The learning unit may train the learning model 140 in advance using supervised learning, unsupervised learning, semi-supervised learning, and/or reinforcement learning. Here, the specific method by which the learning unit trains the learning model 140 using training data is common in the relevant field, and thus a detailed description thereof will be omitted.

The mode determination unit 110 may be configured to determine the voice interaction mode using the learning model 140. The feedback provision unit 120 may be configured to determine a response intent using the learning model 140 and provide a feedback to the user in a voice form. The mode change unit 130 may change or maintain the voice interaction mode using the learning model 140.

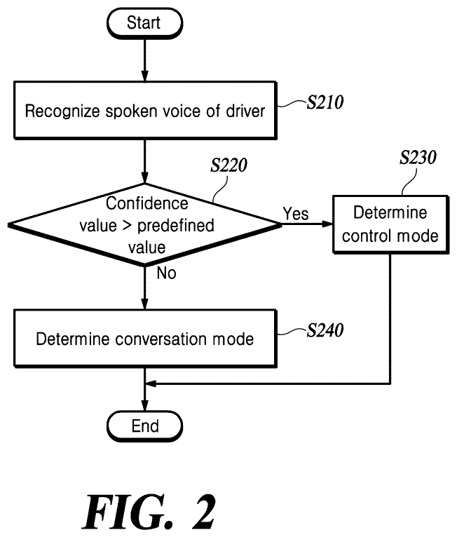

FIG. 2 is a flowchart illustrating a process of determining a voice interaction mode according to an exemplary embodiment of the present disclosure.

Referring to FIG. 2, the mode determination unit 110 recognizes a user's spoken voice (S210). The mode determination unit 110 is configured to determine whether a confidence value determined using the user's spoken voice is greater than a predefined value (S220). Here, the confidence value may be a value between 0 and 1, and the predefined value may be 0.5, but the present disclosure is not limited thereto. The confidence value may be determined using instructions, interrogatives, greetings, and words included in the user's spoken voice. For example, if the user's spoken voice includes control-related words such as “search”, “change”, “play”, and “set”, the mode determination unit 110 may be configured to determine the confidence value as a value close to 1. For example, if the user's spoken voice includes conversation-related words such as “explanation”, “greeting”, “chat”, and “question”, the mode determination unit 110 may be configured to determine the confidence value as a value close to 0.

Upon determining that the confidence value is greater than the predefined value (S220—YES), the mode determination unit 110 is configured to determine the control mode as the voice interaction mode (S230). Upon determining that the confidence value is not greater than the predefined value (S220—NO), the mode determination unit 110 is configured to determine the conversation mode as the voice interaction mode (S240).

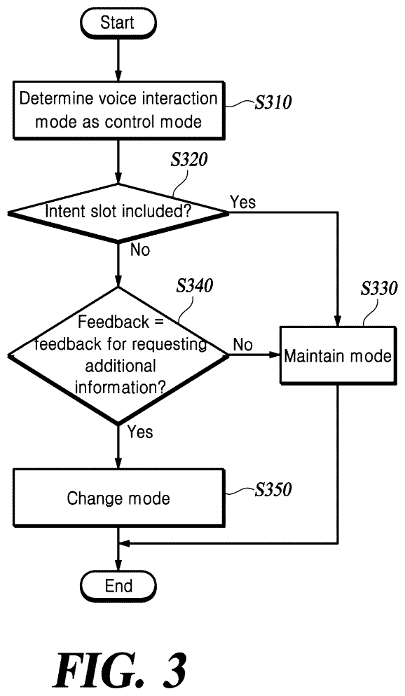

FIG. 3 is a flowchart illustrating a process of changing or maintaining the voice interaction mode according to an exemplary embodiment of the present disclosure.

Referring to FIG. 3, the mode determination unit 110 is configured to determine the voice interaction mode as the control mode according to a voice spoken by the user while the voice interaction mode is maintained as the conversation mode (S310). Here, the confidence value determined by the mode determination unit 110 using the user's spoken voice may be greater than the predefined value. The mode change unit 130 is configured to determine whether an intent slot is included in the user's spoken voice (S320). For example, if the user's spoken voice is “Search for a nearby gas station”, the intent slot is “near”, and thus it can be determined that an intent slot is included in the user's spoken voice. For example, if the user's spoken voice is “Search for a popular song”, the intent slot is “popular”, and thus it can be determined that an intent slot is included in the user's spoken voice.

If an intent slot is included in the user's spoken voice (S320—YES), the mode change unit 130 maintains the voice interaction mode as the control mode (S330). If no intent slot is included in the user's spoken voice (S320—NO), the mode change unit 130 is configured to determine whether a feedback provided before the user's current spoken voice is a feedback for requesting additional information (S340). For example, if the feedback provided before the user's current spoken voice is “Do you have any additional questions?”, the mode change unit 130 may be configured to determine that the feedback provided before the user's current spoken voice is a feedback for requesting additional information. For example, if the feedback provided before the user's current spoken voice is “Please tell me the title or author of the book”, the mode change unit 130 may be configured to determine that the feedback provided before the user's current spoken voice is a feedback for requesting additional information.

If the feedback provided before the user's current spoken voice is not a feedback for requesting additional information (S340—NO), the mode change unit 130 maintains the voice interaction mode as the control mode (S330). If the feedback provided before the user's current spoken voice is check feedback (S340—YES), the mode change unit 130 changes the voice interaction mode from the control mode to the conversation mode (S350).

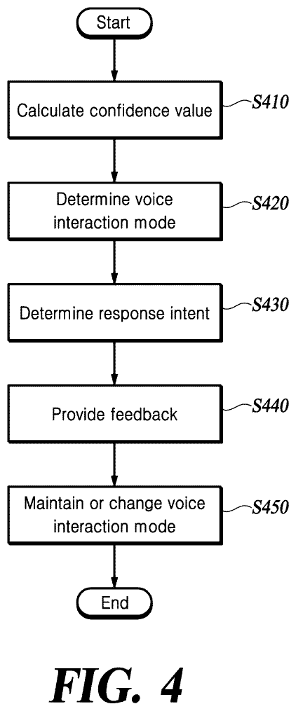

FIG. 4 is a flowchart illustrating a method of providing a service for voice interaction in a vehicle according to an exemplary embodiment of the present disclosure.

Referring to FIG. 4, the mode determination unit 110 is configured to determine a confidence value using a first spoken voice of a user (S410). The mode determination unit 110 compares the confidence value with a predefined value to determine a voice interaction mode (S420). The voice interaction mode may include a first mode and a second mode. The first mode may be a mode for providing a response to a user, and the second mode may be a mode for performing a control operation. The control operation may be an operation of understanding the user's spoken voice and performing control corresponding to the user's intent. When the voice interaction mode is determined as the first mode, the feedback provision unit 120 is configured to determine a response intent using the first spoken voice (S430). The response intent may be an intent to be conveyed to the user. The feedback provision unit 120 provides a feedback to the user using the response intent (S440). The mode change unit 130 maintains or changes the voice interaction mode based on whether a second spoken voice of the user includes an intent slot, and the feedback (S450).

The first spoken voice may be a voice spoken by the user before the feedback is provided, and the second spoken voice may be a voice spoken by the user after the feedback is provided. The intent slot may be a slot reflecting the user's intent. The process of determining the confidence value may include a process of determining the confidence value using instructions, interrogatives, greetings, and words included in the first spoken voice. The process of determining the voice interaction mode may include a process of determining the voice interaction mode as the first mode when the confidence value is less than or equal to the predefined value, and a process of determining the voice interaction mode as the second mode when the confidence value is greater than the predefined value. The process of providing a feedback to the user may include a process of providing a feedback for requesting additional information to the user when the response intent is an intent to request information or an intent to ask a question.

The process of maintaining or changing the voice interaction mode may include a process of maintaining the voice interaction mode as the second mode if the voice interaction mode is determined to be the second mode based on the second spoken voice and the second spoken voice includes an intent slot. The process of maintaining or changing the voice interaction mode may include a process of changing the voice interaction mode from the second mode to the first mode if the voice interaction mode is determined to be the second mode based on the second spoken voice, the second spoken voice does not include an intent slot, and a feedback for requesting additional information is provided to the user. The process of maintaining or changing the voice interaction mode may include a process of maintaining the voice interaction mode as the second mode if the voice interaction mode is determined to be the second mode based on the second spoken voice, the second spoken voice does not include an intent slot, and a feedback other than a feedback for requesting additional information is provided to the user.

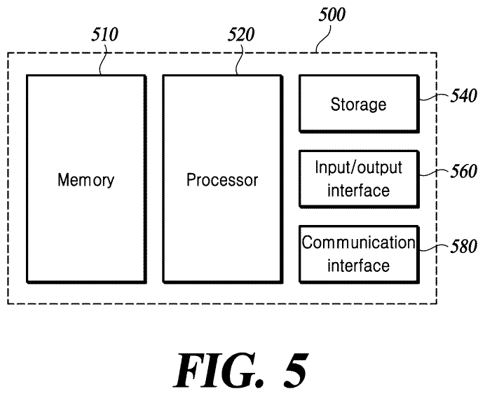

FIG. 5 is a block diagram schematically illustrating an exemplary computing device that can be used to implement the method according to an exemplary embodiment of the present disclosure.

Referring to FIG. 5, the computing device 500 may include some or all of a memory 510, a processor 520, a storage 540, an input/output interface 560, and a communication interface 580. The computing device 500 may structurally and/or functionally include at least a part of the voice interaction service provision apparatus 10. The computing device 500 may be a portable computing device such as a laptop computer or a smartphone as well as a stationary computing device such as a desktop computer, a server, or an AI accelerator.

The memory 510 may store a program that causes the processor 520 to perform a method or an operation according to various embodiments of the present disclosure. For example, the program may include a plurality of instructions executable by the processor 520, and the method illustrated in FIG. 4 may be performed by the processor 520 executing the plurality of instructions.

The memory 510 may be a single memory or multiple memories. In the instant case, information required to perform a method or an operation according to various embodiments of the present disclosure may be stored in a single memory or divided and stored in multiple memories. When the memory 510 includes multiple memories, the multiple memories may be physically separated.

The memory 510 may include at least one of a volatile memory or a nonvolatile memory. The volatile memory may include a static random access memory (SRAM) or a dynamic random access memory DRAM), and the nonvolatile memory may include a flash memory.

The processor 520 may include at least one core configured for executing at least one instruction. The processor 520 may execute the instructions stored in the memory 510. The processor 520 may be a single processor or a plurality of processors.

The storage 540 maintains stored data even when power supplied to the computing device 500 is cut off. For example, the storage 540 may include a nonvolatile memory and may include storage media such as a magnetic tape, an optical disc, and a magnetic disk.

A program stored in the storage 540 may be loaded into the memory 510 before being executed by the processor 520. The storage 540 may store a file written in a programming language, and a program generated from the file by a compiler or the like may be loaded into the memory 510. The storage 540 may store data to be processed by the processor 520 and/or data processed by the processor 520.

The input/output interface 560 may include an input device such as a keyboard, a mouse, etc., and an output device such as a display device, a printer, etc. The user may trigger execution of a program by the processor 520 and/or check a processing result of the processor 520 through the input/output interface.

The communication interface 580 may provide access to an external network. For example, the computing device 500 may communicate with other devices through the communication interface 580.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a non-transitory storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a compact disc ROM (CD-ROM), magnetic tape, a floppy disk, a memory card, a hard disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present specification as being sequentially performed, this is merely an exemplary description of the technical idea of one embodiment of the present disclosure. In other words, those skilled in the art to which one embodiment of the present disclosure belongs may appreciate that various modifications and changes may be made without departing from essential features of an exemplary embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the exemplary embodiments is not limited by the illustrations. Accordingly, one of ordinary skill would understand that the scope of the claimed invention is not to be limited by the above explicitly described embodiments but by the claims and equivalents thereof.

What is claimed is:

1. An apparatus for providing a voice interaction service, the apparatus comprising:
a mode determination unit configured to determine a confidence value using a first spoken voice of a user and compare the confidence value with a predefined value to determine a voice interaction mode, the voice interaction mode including a first mode and a second mode, the first mode being a mode for providing a response to the user, the second mode being a mode for performing a control operation, the control operation being an operation of understanding the user's spoken voice and controlling at least one in-vehicle device in accordance with the user's intent;
a feedback provision unit configured to determine a response intent using the first spoken voice based on determining the voice interaction mode as the first mode and provide a feedback to the user using the response intent, the response intent being an intent to be conveyed to the user; and
a mode change unit configured to maintain or change the voice interaction mode based on whether a second spoken voice of the user includes an intent slot, and the feedback,
wherein the first spoken voice is a voice spoken by the user before the feedback is provided, the second spoken voice is a voice spoken by the user after the feedback is provided, and the intent slot is a slot reflecting a user's intent.

2. The apparatus of claim 1, wherein the mode determination unit is further configured to:
determine the confidence value using instructions, interrogatives, greetings, and words included in the first spoken voice;
determine the voice interaction mode as the first mode based on the confidence value less than or equal to the predefined value; and
determine the voice interaction mode as the second mode based on the confidence value greater than the predefined value.

3. The apparatus of claim 1, wherein the feedback provision unit is further configured to:
provide a feedback for requesting additional information to the user based on the response intent which is an intent to request information or an intent to ask a question.

4. The apparatus of claim 1, wherein the mode change unit is further configured to:
maintain the voice interaction mode as the second mode based on determining the voice interaction mode as the second mode based on the second spoken voice and the intent slot being included in the second spoken voice.

5. The apparatus of claim 1, wherein the mode change unit is further configured to:
change the voice interaction mode from the second mode to the first mode based on determining the voice interaction mode as the second mode based on the second spoken voice, the intent slot not being included in the second spoken voice, and a feedback for requesting additional information being provided to the user.

6. The apparatus of claim 1, wherein the mode change unit is further configured to:
maintain the voice interaction mode as the second mode based on determining the voice interaction mode as the second mode based on the second spoken voice, the intent slot not being included in the second spoken voice, and a feedback other than a feedback for requesting additional information being provided to the user.

7. A method performed by an apparatus for providing a voice interaction service, the method comprising:
determining, by a processor, a confidence value using a first spoken voice of a user;
comparing, by the processor, the confidence value with a predefined value to determine a voice interaction mode, the voice interaction mode including a first mode and a second mode, the first mode being a mode for providing a response to the user, the second mode being a mode for performing a control operation, the control operation being an operation of understanding the user's spoken voice and controlling at least one in-vehicle device in accordance with the user's intent;
determining, by the processor, a response intent using the first spoken voice based on determining the voice interaction mode as the first mode, the response intent being an intent to be conveyed to the user;
providing, by the processor, a feedback to the user using the response intent; and
maintaining or changing, by the processor, the voice interaction mode based on whether a second spoken voice of the user includes an intent slot, and the feedback,
wherein the first spoken voice is a voice spoken by the user before the feedback is provided, the second spoken voice is a voice spoken by the user after the feedback is provided, and the intent slot is a slot reflecting a user's intent.

8. The method of claim 7, wherein the determining of the confidence value comprises determining the confidence value using instructions, interrogatives, greetings, and words included in the first spoken voice.

9. The method of claim 7, wherein the determining of the voice interaction mode comprises:
determining the voice interaction mode as the first mode based on the confidence value less than or equal to the predefined value; and
determining the voice interaction mode as the second mode based on the confidence value greater than the predefined value.

10. The method of claim 7, wherein the providing of the feedback to the user comprises providing a feedback for requesting additional information to the user based on the response intent which is an intent to request information or an intent to ask a question.

11. The method of claim 10, wherein the maintaining or the changing of the voice interaction mode comprises maintaining the voice interaction mode as the second mode based on determining the voice interaction mode as the second mode based on the second spoken voice and the intent slot being included in the second spoken voice.

12. The method of claim 10, wherein the maintaining or the changing of the voice interaction mode comprises changing the voice interaction mode from the second mode to the first mode based on determining the voice interaction mode as the second mode based on the second spoken voice, the intent slot not being included in the second spoken voice, and a feedback for requesting additional information being provided to the user.

13. The method of claim 10, wherein the maintaining or the changing of the voice interaction mode comprises maintaining the voice interaction mode as the second mode based on determining the voice interaction mode as the second mode based on the second spoken voice, the intent slot not being included in the second spoken voice, and a feedback other than a feedback for requesting additional information being provided to the user.

14. A non-transitory computer-readable recording medium storing instructions, the instructions executed by a computer causing the computer to perform:
determining a confidence value using a first spoken voice of a user;
comparing the confidence value with a predefined value to determine a voice interaction mode, the voice interaction mode including a first mode and a second mode, the first mode being a mode for providing a response to the user, the second mode being a mode for performing a control operation, the control operation being an operation of understanding the user's spoken voice and controlling at least one in-vehicle device in accordance with the user's intent;
determining a response intent using the first spoken voice based on determining the voice interaction mode as the first mode, the response intent being an intent to be conveyed to the user;
providing a feedback to the user using the response intent; and
maintaining or changing the voice interaction mode based on whether a second spoken voice of the user includes an intent slot, and the feedback,
wherein the first spoken voice is a voice spoken by the user before the feedback is provided, the second spoken voice is a voice spoken by the user after the feedback is provided, and the intent slot is a slot reflecting a user's intent.
